(19) United States
(12) Patent Application Publication
(10) Pub. No.: US 2026/0115829 A1
(43) Pub. Date: Apr. 30, 2026

(54) LASER LINE-BEAM GENERATION BY STITCHING TOGETHER HOMOGENIZED BEAMS

(71) Applicant: DILAS Diodenlaser GmbH, Mainz (DE)

(72) Inventors: Andreas BAYER, Mainz (DE); Marie Jensby DELANEY, Winthrop, WA (US)

(73) Assignee: DILAS Diodenlaser GmbH, Mainz (DE)

(21) Appl. No.: 18/933,627

(22) Filed: Oct. 31, 2024

(51) Int. Cl. B23K 26/06; B23K 26/064; B23K 26/073; B23K 26/352; B23K 101/38; H01M 4/04

(52) U.S. Cl. CPC B23K 26/0617; B23K 26/064; B23K 26/0738; B23K 26/352; H01M 4/0402; B23K 2101/38

(57) ABSTRACT

A laser system for generating a line beam includes a plurality of laser sources to generate a plurality of laser beams, light pipes arranged to transmit and homogenize the laser beams to transform the laser beams into homogenized laser beams, and relay optics to direct and image the homogenized laser beams from the light pipes onto a common focal plane, whereby the homogenized laser beams form a line beam that, in the common focal plane, includes images of the output ends of the light pipes stitched together along a line-axis of the line beam. Adjacent images in the common focal plane are non-overlapping while having overlapping projections onto the line-axis or onto another axis that is orthogonal to a transport direction of a workpiece through the line beam. The overlapping projections average defocusing-induced seam-effects over a larger region and thus lessen their impact on the laser irradiation process.

### TECHNICAL FIELD OF THE INVENTION

The present invention relates in general to laser systems for generating a line beam, for example for use in laser drying of battery-electrode coatings. The present invention relates in particular to generating a line beam by stitching together multiple homogenized laser beams.

### DISCUSSION OF BACKGROUND ART

In large part due to their high energy density, electrochemical batteries such as lithium-ion batteries are the preferred power source in many different applications ranging from small portable electronic devices to electric vehicles. The basic unit of such a battery cell consists of an anode, a cathode, and a separator therebetween. Each of the anode and cathode is a metal foil coated with an active material. The active material is the component that participates in the electrochemical reactions within the battery. The active material of the cathode is predominantly an oxide that contains mobile ions, for example lithium or sodium. The active material of the anode typically consists primarily of graphite or silicon.

For both the cathode and the anode, the active material is coated on the metal foil in the form of a slurry. In a typical manufacturing line, a large coil of metal foil is provided on a reel. The metal foil is transferred from this initial reel to another reel via a coating apparatus. The coating apparatus forms a coating along the length of the metal foil. The slurry deposited by the coating apparatus is a mixture of the active material, a binder that helps adhere the active material to the metal foil, and a solvent used to ensure that the active material and binder can be evenly mixed and applied to the metallic foil. The coating apparatus subjects the slurry to a drying process that removes the solvent. This drying process is conventionally carried out using convection ovens or infrared-lamp drying. While convection ovens are widely used for this purpose, they are physically large and consume a large amount of energy. Infrared lamps provide a more compact solution as well as some improvement in terms of energy efficiency. Yet, the conventional drying process, whether performed with convection ovens or infrared lamps, is still one of the most energy consuming steps of electrochemical battery production.

A line beam is a laser beam that has a long, narrow cross section resembling a line. There are several ways to shape a circular laser beam into a line beam. Most commonly, one or more cylindrical lenses are used to shape a circular Gaussian laser beam into a line beam. Line beams are commonly utilized in materials processing tasks, such as annealing, especially within the context of semiconductor processing. Line beams are also employed in imaging and scanning applications, including barcode scanning, three-dimensional profiling, and biomedical imaging. Some of these applications benefit from, or require, that the line beam has an approximately uniform intensity along its length so as to provide consistent illumination of the target. In these situations, the laser intensity distribution along the length of the line is ideally a top-hat distribution characterized by an approximately constant intensity along the full length of the line with sharp drop-offs at the ends. Transformation of a circular Gaussian laser beam into a line beam with a top-hat distribution can be achieved with, e.g., a lens array or a Powell lens. A Powell lens is an aspheric cylindrical lens with a uniquely shaped apex.

Line beams can also be generated by stitching together several individual laser beams. For example, the collection of laser beams emitted by a linear array of laser sources can be arranged next to each other to form a line beam. In one example of this approach, the array of laser sources emits a corresponding array of Gaussian laser beams. This array of laser beams is directed to a target plane, where each individual laser beam partially overlaps with each adjacent laser beam, such that the collection of laser beams forms an uninterrupted line beam. The overlap between adjacent laser beams may be tuned such that the intensity distribution along the line axis of the line beam resembles a top-hat distribution with residual modulations originating from the Gaussian nature of the individual laser beams.

### SUMMARY OF THE INVENTION

Laser drying is as an alternative to conventional methods for drying battery electrode coatings. Laser drying can be significantly more efficient than convective and even infrared drying, especially when using high-efficiency laser sources. Laser drying of battery electrode coatings can be performed at an energy consumption level that is only between about 10% and 50% of the energy consumption of convection ovens and infrared lamps. In the battery electrode coating process, a coating lane on a metal foil may be dried by passing the metal foil through a laser line-beam having a length that matches the width of the coating lane.

Disclosed herein are laser systems for generating a line beam by stitching together multiple homogenized laser beams. The laser systems include a plurality of laser sources and respective light pipes for homogenizing each laser beam emitted by the laser sources. Relay optics image the homogenized beams from the light pipes onto a common focal plane to form a line beam consisting of images of the light pipes stitched together along a line. In other words, each image constitutes a respective segment of the line beam. The present laser systems benefit from the use of relatively simple light pipes to achieve high homogeneity for each individual laser beam contributing to the line beam in the common focal plane.

It is possible to eliminate any evidence of “seams” between the images in the common focal plane by generating the images such that there is no gap and no overlap between adjacent images. For example, an array of identical, rectangular light pipes may produce a corresponding array of identical, parallel, rectangular images in the common focal plane to form a rectangular line beam, with the images being positioned exactly such that there is no gap and no overlap between adjacent images. This “no-gap rectangular” design can produce a line beam with a top-hat intensity distribution in the common focal plane. However, we have realized that the performance of the no-gap rectangular design is highly sensitive to defocusing, such as will be encountered when a to-be-processed workpiece is somewhat displaced from the common focal plane. Defocusing causes the no-gap rectangular design to produce undesirable gaps or intensity peaks at the seams between individual contributing beams. This can lead to non-uniform processing, for example resulting in incomplete drying or over-drying in battery-electrode coating applications. Either one of these two issues can be detrimental to the outcome of the battery-electrode coating process. Incomplete drying may prevent portions of the coating from being secured to the metal foil, and over-dried portions of the coating are prone to delamination from the metal foil.

The present laser systems reduce the severity of effects caused by defocusing, as compared to the no-gap rectangular design, by employing (a) unusually shaped light pipes and thus unusually shaped images in the common focal plane and/or (b) unusual arrangements of the images in the common focal plane. The present laser systems rely on the images being nonoverlapping in the common focal plane yet having overlapping projections onto the line-beam axis or onto another axis that is orthogonal to a transport direction of a workpiece through the line beam. As experienced by a workpiece traveling through the line beam, the overlapping projections average defocusing-induced seam-effects over a larger region and thus lessen their impact on the laser irradiation process. The present laser systems are therefore useful in laser processing applications, such as laser drying of battery-electrode coatings, that require a line beam and impose requirements on laser irradiation uniformity while being subject to defocusing errors.

In one aspect of the invention, a laser system for generating a line beam includes a plurality of laser sources to generate a respective plurality of laser beams, and a plurality of light pipes arranged to transmit and homogenize the plurality of laser beams, respectively, so as to transform the plurality of laser beams into a respective plurality of homogenized laser beams. The laser system also includes relay optics arranged to direct and image the homogenized laser beams from respective output ends of the light pipes onto a common focal plane, whereby the homogenized laser beams form a line beam that, in the common focal plane, includes respective images of the output ends of the light pipes stitched together along a line-axis of the line beam. Each mutually-adjacent pair of the images in the common focal plane are non-overlapping while having overlapping projections onto the line-axis.

In another aspect of the invention, a laser apparatus for processing a workpiece includes a laser system and a transport system. The laser system includes a plurality of laser sources to generate a respective plurality of laser beams, and a plurality of light pipes arranged to transmit and homogenize the plurality of laser beams, respectively, so as to transform the plurality of laser beams into a respective plurality of homogenized laser beams. The laser system further includes relay optics arranged to direct and image the homogenized laser beams from respective output ends of the light pipes onto a common focal plane, whereby the homogenized laser beams form a line beam that, in the common focal plane, includes respective images of the output ends of the light pipes arranged along a line-axis of the line beam. The transport system is configured to drive the workpiece through the line beam along a transport direction that is parallel to the common focal plane and at an oblique angle to the line-axis. In the common focal plane, each mutually-adjacent pair of the images are non-overlapping while having overlapping projections onto a first axis that is orthogonal to the transport direction and contained in the common focal plane.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 illustrates a laser system for generating a line beam by stitching together a plurality of laser beams homogenized by respective light pipes, according to an embodiment. In the depicted example, each of the contributing homogenized laser beams forms a trapezoidal segment of the line beam.

FIG. 2 illustrates a trapezoidal light pipe that may be implemented in the laser system of FIG. 1, according to an embodiment.

FIG. 3 is a more detailed illustration of imaging of the homogenized laser beams from the light pipes to a common focal plane in the laser system of FIG. 1, in an example where the light-pipe output ends and the corresponding images thereof, in the common focal plane, are shaped as isosceles trapezoids.

FIG. 4 illustrates a coating apparatus that utilizes the laser system of FIG. 1 to laser dry a coating lane on a metal foil, according to an embodiment.

FIGS. 5A-C illustrate defocusing effects that arise in a no-gap rectangular design where a rectangular line beam is composed of a linear array of individual rectangular images seamlessly stitched together in a common focal plane.

FIGS. 6A-C illustrate the behavior of the FIG. 3 line beam, composed of isosceles-trapezoidal images seamlessly stitched together in a common focal plane, under different focusing conditions.

FIGS. 7A-C illustrate a line beam composed of isosceles-trapezoidal images offset from the line-axis in alternating directions to produce gaps between adjacent images, as well as the behavior of this line beam under different focusing conditions, in an embodiment of the laser system of FIG. 1.

FIGS. 8A-C illustrate a line beam composed of isosceles-trapezoidal images offset from each other along the line-axis to produce gaps between adjacent images, as well as the behavior of this line beam under different focusing conditions, in an embodiment of the laser system of FIG. 1.

FIG. 9 illustrates another configuration of trapezoidal light-pipe output ends in an embodiment of the laser system of FIG. 1, as well as a resulting line beam in the common focal plane. This configuration incorporates right-trapezoidal shapes to achieve a strict top-hat exposure profile.

FIG. 10 illustrates a configuration of triangular light-pipe output ends in an embodiment of the laser system of FIG. 1, as well as a resulting line beam generated in the common focal plane.

FIG. 11 illustrates a configuration of parallelogram-shaped light-pipe output ends in an embodiment of the laser system of FIG. 1, as well as a resulting, seamless line beam generated in the common focal plane.

FIG. 12 illustrates another configuration of parallelogram-shaped light-pipe output ends in an embodiment of the laser system of FIG. 1, as well as a resulting line beam generated in the common focal plane, wherein the images contributing to the line beam are offset along the line-axis to produce gaps between adjacent images.

FIG. 13 illustrates yet another configuration of parallelogram-shaped light-pipe output ends in an embodiment of the laser system of FIG. 1, as well as a resulting line beam generated in the common focal plane, wherein there are gaps between the images contributing to the line beam.

FIGS. 14A-C illustrate a configuration of rectangular light-pipe output ends, in an embodiment of the laser system of FIG. 1, generating a line beam composed of rectangular images that advantageously are separated by gaps while having overlapping projections onto an axis that may be arranged orthogonally to a travel direction of a workpiece.

FIGS. 15A and 15B illustrate another configuration of rectangular light-pipe output ends, in another embodiment of the laser system of FIG. 1, generating a line beam composed of rectangular images that advantageously are separated by gaps while having overlapping projections onto an axis that may be arranged orthogonally to a travel direction of a workpiece.

FIGS. 16A and 16B illustrate a configuration of parallel rectangular light-pipe output ends, in an embodiment of the laser system of FIG. 1, generating a rectangular line beam composed of rectangular images that are separated by gaps while having projection-overlaps with respect to an axis that is at an oblique angle to the line-beam axis but may be arranged orthogonally to a travel direction of a workpiece.

FIG. 17 illustrates a coating apparatus that utilizes the laser system of FIG. 1 to laser dry a coating lane on a metal foil, wherein the laser system of FIG. 1 implements rectangular light pipe output ends according to the configuration of FIG. 16 and is oriented such that the line beam is at an oblique angle to the travel direction of the metal foil, according to an embodiment.

### DETAILED DESCRIPTION OF THE INVENTION

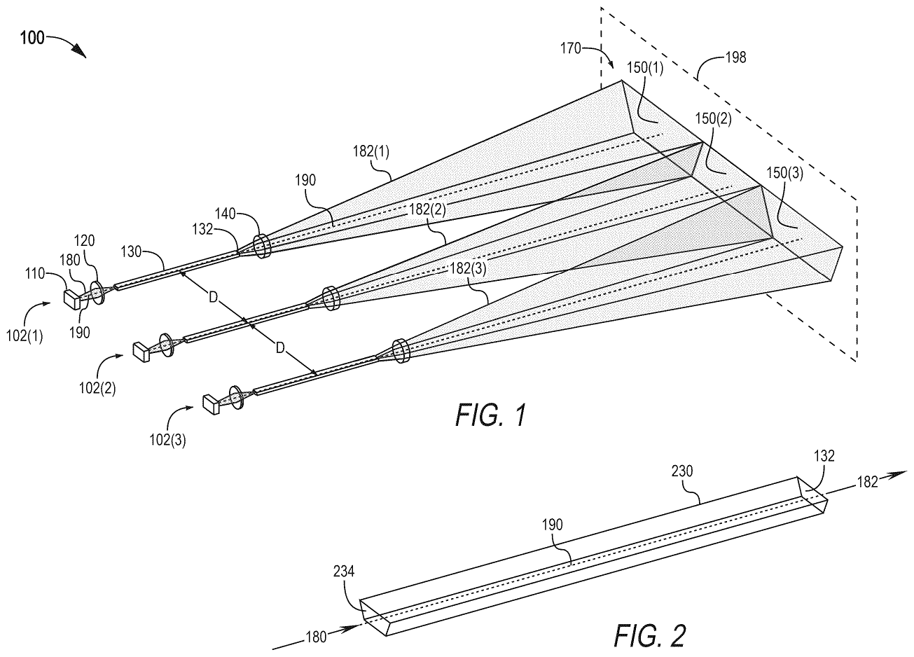

Referring now to the drawings, wherein like components are designated by like numerals, FIG. 1 illustrates one laser system 100 for generating a line beam by stitching together a plurality of laser beams homogenized by light pipes. Laser system 100 includes a plurality of assemblies 102. Each assembly 102 generates a homogenized laser beam and images the homogenized laser beam onto a common focal plane to form a segment of a line beam. In the depicted embodiment, system 100 includes three assemblies 102(1), 102(2), and 102(3) arranged in a linear array. More generally, system 100 includes two or more assemblies 102 that share a common focal plane but may or may not be arranged in a linear array.

Each assembly 102 includes a laser source 110, a light pipe 130, and imaging optics 140. Source 110 generates a laser beam 180 that is coupled into light pipe 130. Optionally, system 100 includes a lens 120 that couples beam 180 from source 110 into light pipe 130. Light pipe 130 guides beam 180 to an output end 132 of light pipe 130. Light pipe 130 homogenizes beam 180 and thereby transforms beam 180 into a homogenized laser beam 182. Imaging optics 140, which may include one or more lenses and/or one or more curved mirrors, image homogenized beam 182 from output end 132 of light pipe 130 onto a focal plane 198. At focal plane 198, homogenized beam 182 forms an image 150 of output end 132. In the depicted embodiment, output end 132 is shaped as an isosceles trapezoid, such that image 150 is an isosceles trapezoid.

Focal plane 198 is common to imaging optics 140 of all assemblies 102. In focal plane 198, the plurality of images 150 generated by the respective assemblies 102 are located along a line to form a line beam 170. Each image 150 constitutes a respective segment of line beam 170.

Laser beam propagation in assembly 102, from source 110 to focal plane 198, takes place along a propagation axis 190. Although depicted as a straight line in FIG. 1, propagation axis 190 may be folded in one or more places. For example, one or more of assemblies 102 may include additional optical elements that steer homogenized beam 182 from light pipe 130 to focal plane 198. Such optical elements may be common to all homogenized beams 182 or separately implemented in one or more individual ones of assemblies 102. Thus, while FIG. 1 depicts only imaging optics 140 between each light pipe 130 and focal plane 198, system 100 may more generally include relay optics that image and direct the plurality of homogenized beams 182 onto focal plane 198.

In the embodiment depicted in FIG. 1, assemblies 102 are arranged in a linear array with parallel propagation axes 190. In this embodiment, sources 110 are arranged in a linear array, and light pipes 130 are arranged in a linear array with equidistant spacings D between light pipes 130. Light pipes 130 may be identical in shape and size, and imaging optics 140 of each assembly 102 may image homogenized beams 182 onto focal plane 198 with the same magnification to produce images 150 with the same shape and size. However, system 100 may also generate images 150 with the same shape and size using light pipes 130 of differing sizes and imaging optics 140 with correspondingly differing magnifications. Without loss of generality, the remainder of this description assumes that at least output ends 132 are arranged in a linear array, and imaging optics 140 of each assembly 102 impose the same magnification. Individual output ends 132 may have respective offsets from an axis of the linear array, without departing from the scope hereof. For example, output ends 132 may be offset from an axis of the linear array in alternating directions.

Light pipe 130 may be made of glass, a crystalline material, or, in relatively low-power applications, an optical-grade plastic. In one embodiment, light pipe 130 guides beam 180 by total internal reflection. In another embodiment, surfaces of light pipe 130, apart from its input and output ends, include a reflective coating that ensures guiding of beam 180. In either embodiment, beam 180 undergoes multiple internal reflections at the walls of light pipe 130, resulting in homogenization of beam 180. In most embodiments, the resulting homogenized beam 182 has an outline that is identical to, or at least resembles, the shape of output end 132. This holds true even if beam 180, as received by light pipe 130, has a different shape, e.g., a circular or elliptical Gaussian profile, although deviations may occur if, e.g., light pipe 130 is not sufficiently long to perfectly homogenize beam 180. At output end 132, the intensity distribution of homogenized beam 182 is at least approximately uniform within the outline defined by the shape of output end 132 and is thus at least approximately characterized by a top-hat profile within this outline. For example, the intensity variation of homogenized beam 185 within the outline defined by the shape of output end 132 may be less than 5%. When the homogenization is perfect, the intensity distribution of homogenized beam 182 is perfectly uniform within the outline defined by the shape of output end 132 and is indeed characterized by a top-hat profile within the outline. Hereinafter, homogenization is assumed to perfect, although it is understood that, e.g., manufacturing imperfections, can cause deviations from perfect homogenization.

Image 150 has the same intensity distribution as homogenized beam 182 at output end 132, apart from being scaled by any magnification imposed by imaging optics 140. The intensity distribution of line beam 170 thereby benefits from the homogeneity imposed by light pipes 130.

FIG. 2 is a more detailed view of one embodiment of light pipe 130, namely a trapezoidal light pipe 230. Trapezoidal light pipe 230 is elongated along the propagation axis 190 of beam 180 in assembly 102. Trapezoidal light pipe 230 has an isosceles-trapezoidal cross section along its full length from its input end 234 to output end 132. Input end 234 and output end 132, as well as the transverse cross section of light pipe 230 therebetween, are of the same shape and size.

Referring again to FIG. 1, output end 132 of the depicted example of light pipe 130 is isosceles-trapezoidal to produce an isosceles-trapezoidal image in focal plane 198. However, the design of light pipe 130 may deviate from that of light pipe 230 and still impose an isosceles-trapezoidal outline on homogenized beam 182. For example, light pipe 130 may gradually taper from an input end of another shape, e.g., circular, to an isosceles-trapezoidal output end.

In the depicted example, where images 150 are isosceles trapezoids, system 100 arranges the isosceles-trapezoidal images in focal plane 198 with no overlap (at least nominally) between adjacent images 150.

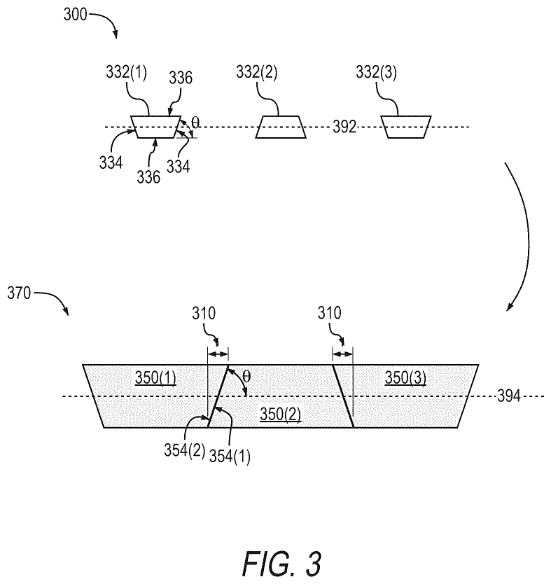

FIG. 3 provides a more detailed illustration of imaging in system 100 from light pipes 130 to focal plane 198, pertaining to the depicted example in FIG. 1 where images 150 are isosceles-trapezoidal. FIG. 3 illustrates imaging in one configuration 300 where output ends 132 and images 150 are shaped as isosceles trapezoids. In configuration 300, light pipes 130 are arranged in a linear array with identical respective isosceles-trapezoidal output ends 332 distributed along an array-axis 392. Bases 336 of each isosceles-trapezoidal output end 332 are parallel to array-axis 392. Legs 334 of each isosceles-trapezoidal output end 332 are at the same oblique angle θ to array-axis 392. Configuration 300 includes three identical, trapezoidal output ends 332(1), 332(2), and 332(3). The middle output end 332(2) has the opposite orientation than output ends 332(1) and 332(3), with respect to array-axis 392.

Configuration 300 is readily generalized to two isosceles-trapezoidal output ends 332 or to four or more isosceles-trapezoidal output ends 332. In such generalizations, adjacent isosceles-trapezoidal output ends 332 have mutually-opposite orientations with respect to array-axis 392.

Imaging of isosceles-trapezoidal output ends 332 onto focal plane 198 produces isosceles-trapezoidal images 350 that cooperate to form a line beam 370 in common focal plane 198. Each image 350 is centered on a line-axis 394 of line beam 370.

Hereinafter, the axis of a line beam in a focal plane is referred to as a “line-axis”. In some cases, not all individual images contributing to the line beam are centered on a common line in the focal plane. In such cases, the line-axis is the linear axis that forms the best fit to the locations of the geometric centers of the individual images in the common focal plane.

By virtue of the alternating orientations of isosceles-trapezoidal output ends 332, isosceles-trapezoidal images 350 also have alternating orientations. This results in adjacent sides of adjacent isosceles-trapezoidal images 350 being parallel to each other, as indicated by side 354(1) of image 350(1) and side 354(2) of image 350(2). In configuration 300, imaging is performed with a magnification that causes images 350 to have no gaps and no overlap therebetween. In this manner, configuration 300 stitches together images 350 such that no seams between the contributing images 350 are visible in line beam 370 in common focal plane 198. In fact, when the homogenization by light pipes 130 is perfect, line beam 370 will have a uniform intensity distribution in common focal plane 198. In configuration 300, adjacent sides, e.g., sides 354(1) and 354(2), coincide with each other. There are other configurations, discussed below, where adjacent sides of adjacent images are parallel to each other without coinciding with each other, or with only partial overlap therebetween, or with zero overlap therebetween.

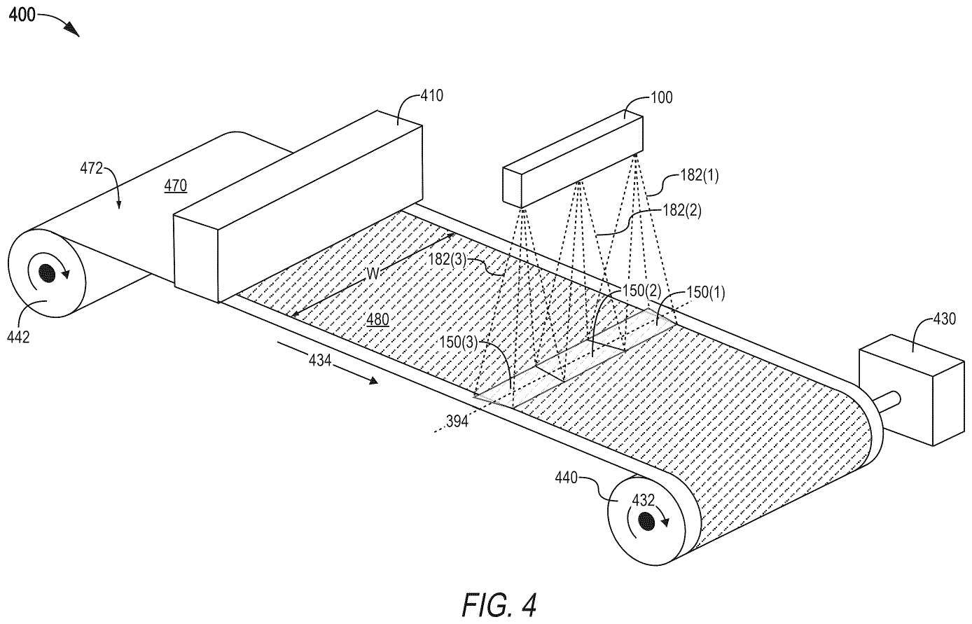

FIG. 4 illustrates one coating apparatus 400 that utilizes laser system 100 to laser dry a coating lane 480 on a metal foil 470. Apparatus 400 may be used in the manufacture of battery electrodes, e.g., electrodes for lithium-ion or sodium-ion batteries. Once coated by apparatus 400, metal foil 470 may be cut to form a large number of coated battery electrodes. Apparatus 400 includes a coating applicator 410, laser system 100, and a transport system 430.

Transport system 430 drives metal foil 470 along a travel direction 434, allowing metal foil 470 to pass beneath coating applicator 410 and laser system 100. In the depicted implementation, transport system 430 pulls metal foil 470 from a feeding reel 442 to a receiving reel 440 by rotating receiving reel 440 as indicated by rotation direction 432. Alternatively, transport system 430 may utilize other techniques for transporting metal foil 470 beneath coating applicator 410 and laser system 100, such as rubberized wheels.

Herein, the terms “beneath” and “above” do not necessarily imply a particular positioning in relation to the direction of gravity. However, depending on the viscosity of the deposited coating material, it may be beneficial to keep the coated surface of metal foil 470 facing up, against the direction of gravity, to prevent the deposited coating material from running and/or detaching from metal foil 470 before the laser drying process is complete.

As metal foil 470 passes beneath coating applicator 410, coating applicator 410 deposits coating material on a surface 472 of metal foil 470 to form coating lane 480 thereon. Coating lane 480 has a width W. In one example, width W is in the range between 1 and 100 centimeters (cm). Until dried, the material of coating lanes 480 may be in the form of a slurry. As deposited, the material of coating lane 480 may include an active material, a binder, and a solvent. In one example, suitable for the manufacture of lithium-ion battery cathodes, metal foil 470 is an aluminum foil, and the material of coating lane 480 includes a lithium oxide. For the manufacture of a lithium-ion battery anodes, metal foil 470 may be made of copper, a copper alloy, or nickel, and the material of coating lane 480 may include graphite and/or silicon.

Laser system 100 is positioned downstream from coating applicator 410 and arranged such that metal foil 470 is, at least nominally, situated in a common focal plane (such as focal plane 198 in FIG. 1) when passing beneath laser system 100. Line beam 170 (see FIG. 1) dries coating lane 480 as it passes beneath laser system 100. The drying process performed by line beam 170 may entail evaporating a solvent included in the deposited coating material.

The laser drying process performed by laser system 100 in apparatus 400 requires that the entire width W of coating lane 480 is exposed to line beam 170, and that no portion of coating lane 480 is exposed to an excessive laser intensity or energy exceeding certain thresholds. Ideally, the entirety of coating lane 480, at least in the interior regions of coating lane 480, is subjected to the same laser intensity and energy, although some degree of deviations typically is acceptable. In some scenarios, it is preferable that edges of coating lane 480 are subjected to lesser laser intensity and energy to prevent overheating in the event that some of line beam 170 extends beyond the width W of coating lane 480 and directly exposes metal foil 470.

In a manner similar to the use of laser system 100 to laser dry coating lane 480 in apparatus 400, laser system 100 may be used to laser dry or otherwise laser-process other types of workpieces. For example, laser system 100 may be used to laser dry ink printed onto a substrate.

Referring again to FIG. 1, system 100 is configured to generate the individual images 150 of line beam 170 with high homogeneity. System 100 is also capable of arranging images 150 such that a workpiece is relatively uniformly irradiated when traveling through line beam 170. Herein, a workpiece is considered “traveling through a line beam” if the relative positioning of the workpiece and the line beam changes such that the workpiece passes through the line beam, whether this is a result of the workpiece, the line beam, or both moving. A workpiece may be subject to a defocused version of line beam 170 if the workpiece is not accurately positioned in focal plane 198. Advantageously, the arrangement of images 150 contributing to line beam 170 is specifically configured to render the irradiation less sensitive to defocusing.

Images 150 are arranged to have overlapping projections onto either the line-axis of line beam 170 or another axis that can be arranged orthogonally to the travel direction of a workpiece traveling through line beam 170. Herein the “projection” of an image onto an axis refers to geometrical projections of a two-dimensional image onto a linear axis that is coplanar with the two-dimensional image. This projection-overlap reduces the effect that defocusing has on the seams between adjacent images 150 and thus on the irradiation of a workpiece traveling through line beam 170. As a result, system 100 relaxes requirements on the accuracy with which a workpiece, to be processed by line beam 170, is placed with respect to focal plane 198. This is an advantage in many laser processing applications, such as in laser drying applications. For example, in coating apparatus 400, it may be challenging to keep a large, thin, and moving metal foil 470 accurately confined in focal plane 198. In coating apparatus 400, laser system 100 allows for some displacement of metal foil 470 from focal plane 198 without the associated defocusing effects having a detrimental on the laser drying process.

Depending on the shape of light pipes 130, especially output ends 132, laser system 100 can generate line beam 170 with many different arrangements of the individual images contributing thereto. In order to ensure homogeneous irradiation with relatively low sensitivity to defocusing, each of the arrangements is characterized by (a) no spatial overlap between the contributing images 150 in focal plane 198 and yet (b) overlapping projections, in focal plane 198, between adjacent images 150. The overlapping projections are with respect to either the line-axis of line beam 170 or another axis that can be oriented orthogonally to the travel direction of a workpiece traveling through line beam 170. Configuration 300 and line beam 370 are one example of such an arrangement. Below, numerous other examples are provided. Some of these examples further reduce defocusing sensitivity by arranging images 150 with gaps therebetween in focal plane 198. It is instructional to first consider a line beam composed of separate images stitched together without overlapping projections onto the line-axis.

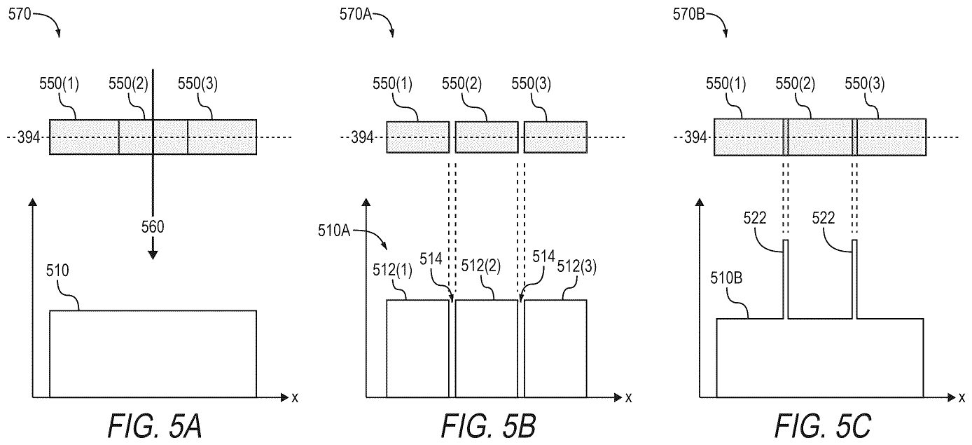

FIGS. 5A-C illustrate defocusing effects that arise in the no-gap rectangular design where a rectangular line beam 570 is composed of a linear array individual rectangular images 550 seamlessly stitched together in a common focal plane. Line beam 570 can be produced by an embodiment of system 100 wherein output ends 132 are rectangular and parallel to each other. FIG. 5A shows line beam 570 in the focal plane. FIG. 5B shows a cross section 570A of line beam 570 taken in a plane that is displaced from the focal plane in a direction where images 550 are smaller than in the focal plane. FIG. 5C shows a cross section 570B of line beam 570 taken in a plane that is displaced from the focal plane in a direction where images 550 are larger than in the focal plane. FIGS. 5A-C also show associated exposure profiles experienced by a workpiece traveling through line beam 570 in a direction 560 orthogonal to line-axis 394 as a function of location x along line-axis 394 (see FIGS. 3 and 4).

Line beam 570 is composed of rectangular images 550(1), 550(2), and 550(3) arranged along line-axis 394. As shown in FIG. 5A, rectangular images 550 are positioned next to each other in the focal plane without gaps or overlaps therebetween, with each rectangular image 550 parallel to line-axis 394. When each image 550 has a uniform intensity distribution, line beam 570 is entirely homogeneous in the focal plane. A workpiece traveling through line beam 570 in focal plane 198 along direction 560 will experience a top-hat exposure profile 510.

However, the effect of defocusing on the homogeneity of line beam 570 and the uniformity of its exposure profile is undesirable. In the defocused state illustrated by cross section 570A in FIG. 5B, there are gaps between images 550. A workpiece traveling through line beam 570 along direction 560 in this plane, will experience an exposure profile 510A that has holes. Exposure profile 510A is composed of separate segments 512 separated by complete holes 514. Some portions of the workpiece will not be irradiated by line beam 570 in this defocused state. In the defocused state illustrated by cross section 570B in FIG. 5C, images 550 overlap. In the overlap regions, the intensity of line beam 570 is approximately doubled, and a workpiece traveling through this defocused state of line beam 570 along direction 560, will experience an exposure profile 510B that has spikes 522 reaching approximately twice the nominal value. Corresponding portions of the workpiece will be excessively irradiated. Both lack of irradiation and excessive irradiation can be detrimental to the outcome of a laser processing task, such as laser drying. Certain embodiments of laser system 100 are configured to intrinsically mitigate these issues. Other embodiments of laser system 100 can be implemented in a laser processing apparatus in a manner that mitigates the issues.

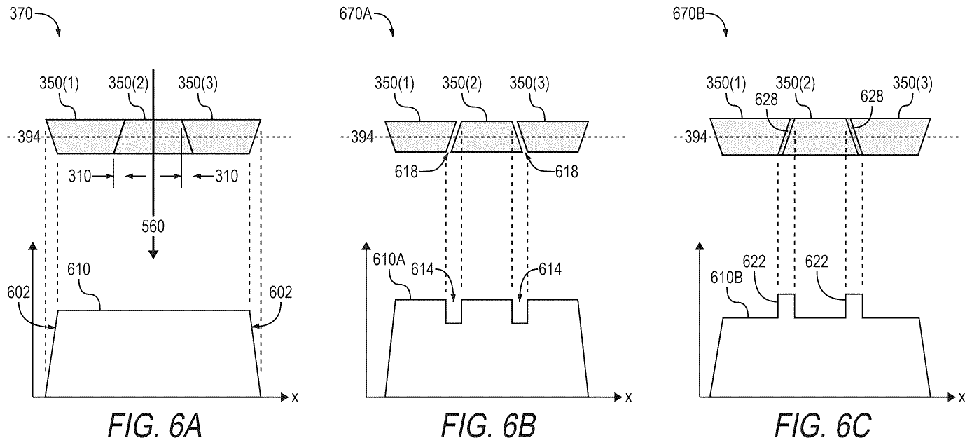

FIGS. 6A-C illustrate the behavior of line beam 370, composed of isosceles-trapezoidal images 350 seamlessly stitched together in a common focal plane, under different focusing conditions. Line beam 370 may be generated by an embodiment of system 100 that implements configuration 300, as discussed above in reference to FIG. 3. As shown in FIG. 6A and as discussed above in reference to FIG. 3, isosceles-trapezoidal images 350 connect seamlessly in focal plane 198 with no overlap and no gaps therebetween, but with projection-overlap regions 310 due to the trapezoidal shapes. A workpiece traveling through line beam 370 along direction 560, orthogonal to line-axis 394, will experience an exposure profile 610 that is a top-hat apart from at edges 602. At edges 602, the trapezoidal shape of images 350 causes the exposure to more gradually taper to zero.

FIGS. 6B and 6C are equivalent to FIGS. 5B and 5C, except for pertaining to line beam 370 composed of isosceles-trapezoidal images 350. FIGS. 6B and 6C demonstrate that, although the intensity distribution of line beam 370 is sensitive to defocusing, the projection-overlap in projection-overlap regions 310 helps mitigate defocusing effects by averaging these effects over a more extended portion of line-axis 394. This results in a more robust and uniform intensity distribution when a workpiece is displaced from focal plane 198.

FIG. 6B shows a cross section 670A of line beam 370 in a plane displaced from focal plane 198 in the direction towards light-pipe output ends 332 (assuming that imaging optics 140 are magnifying). At this location, gaps 618 exist between adjacent images 350. Despite the defocusing, the exposure profile 610A maintains its overall shape, with only minor dips 614 in the regions of gaps 618. These dips are significantly less severe than the complete holes 514 observed in the no-gap rectangular design (FIG. 5B). In one example, each dip 614 produces an exposure reduction of less than 20%. FIG. 6C depicts a cross section 670B of line beam 370 in a plane displaced from focal plane 198 in the direction away from output ends 332 (again assuming that imaging optics 140 are magnifying). In this defocused state, the corresponding exposure profile 610B shows intensity peaks 622 that are less pronounced than the sharp spikes 522 seen in the no-gap rectangular design (FIG. 5C). The trapezoidal image-shapes employed in line beam 370 thus provide significant advantages over the no-gap rectangular design. However, due to the seamless connection between images 350 in focal plane 198, adjacent images 350 overlap in cross section 670B, thus producing local regions 628 of high intensity. Such local high-intensity regions are undesirable in some applications.

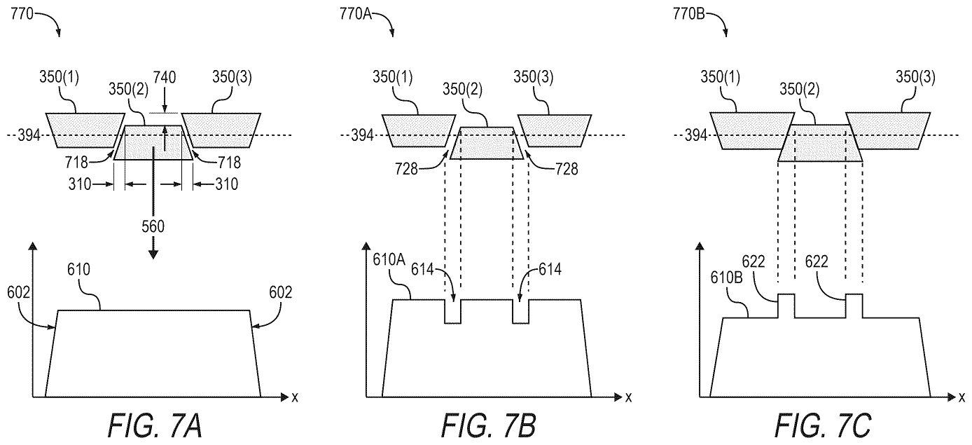

FIGS. 7A-C illustrate a line beam 770 composed of isosceles-trapezoidal images 350 offset from line-axis 394 in alternating directions to produce gaps between adjacent images 350, as well as the behavior of line beam 770 under different focusing conditions. Line beam 770 may be generated by an embodiment of system 100 implementing a modification of configuration 300 (see FIG. 3), wherein output ends 332 are offset from array-axis 392 in alternating directions in the dimension orthogonal to array-axis 392 (and bases 336). FIG. 7A shows line beam 770 in focal plane 198. In line beam 770, isosceles-trapezoidal images 350(1), 350(2), and 350(3) are arranged with alternating offsets relative to line-axis 394, as indicated by offset 740. Since offset 740 is orthogonal to line-axis 394, line beam 770 maintains the same exposure profiles as line beam 370 in focal plane 198 as well as in locations displaced from focal plane 198, for a workpiece traveling through the line beam orthogonally to line-axis 394. However, offset 740 produces gaps 718 between adjacent images in focal plane 198. To further clarify, if offset 740 was eliminated, gaps 718 would disappear and the resulting line beam would be identical to line beam 370. Advantageously, the presence of gaps 718 allows for some amount of defocusing, in a direction that enlarges images 350, without introducing actual overlap between adjacent images 350.

FIG. 7B shows a cross section 770A of line beam 770 in a plane displaced from focal plane 198 in the direction towards light-pipe output ends 332 (assuming that imaging optics 140 are magnifying). At this location, there are larger gaps 728 between adjacent images 350. FIG. 7C depicts a cross section 770B of line beam 770 in a plane displaced from focal plane 198 in the direction away from output ends 332 (assuming that imaging optics 140 are magnifying). Unlike cross section 670B of line beam 370, the corresponding defocused state of cross section 770B does, by virtue of gaps 718 between images 350 in focal plane 198, not exhibit local regions 628 of high intensity. This is an advantage of line beam 770 over line beam 370.

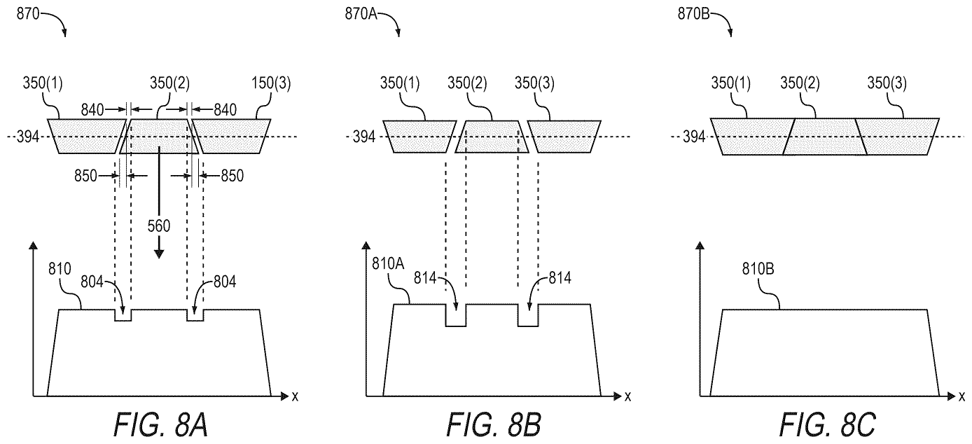

FIGS. 8A-C illustrate a line beam 870 composed of isosceles-trapezoidal images 350 offset from each other along line-axis 394 to produce gaps therebetween, as well as the behavior of line beam 870 under different focusing conditions. Line beam 870 may be generated by an embodiment of system 100 implementing a modification of configuration 300 (see FIG. 3) with greater distances between output ends 332. FIG. 8A shows line beam 870 in focal plane 198. In line beam 870, isosceles-trapezoidal images 350(1), 350(2), and 350(3) are centered on line-axis 394 and situated with gaps 840 between adjacent images 350. Gaps 840 are sufficiently small that projections of adjacent images 350 onto line-axis 394 still overlap in projection-overlap regions 850.

FIGS. 8B and 8C show cross sections 870A and 870B of line beam 870 respectively taken before and after focal plane 198 (assuming that imaging optics 140 are magnifying). FIGS. 8B and 8C are equivalent to FIGS. 7B and 7C pertaining to line beam 770. Similarly to line beam 770, gaps 840 between images 350 of line beam 870 in focal plane 198 lead to larger gaps between images 350 in cross section 870A and, advantageously, prevent actual overlap between images 350 in cross section 870B.

The characteristics of line beam 870 differ from those of line beam 770 in the exposure profiles experienced by a workpiece traveling through line beam 870 in direction 560 orthogonal to line-axis 394. In focal plane 198, line beam 870 is characterized by an exposure profile 810 that has mild dips 804 due to the offsets of images 350 being along rather than orthogonal to line-axis 394. In cross section 870A, line beam 870 is characterized by an exposure profile 810A that has more pronounced dips 814. In cross section 870B, however, the exposure profile of line beam 870 exhibits neither dips nor peaks.

Each of line beams 370, 770, and 870 is readily generalized from the depicted arrangement, including three isosceles-trapezoidal images 350, to including two or more isosceles-trapezoidal images 350 arranged along line-axis 394.

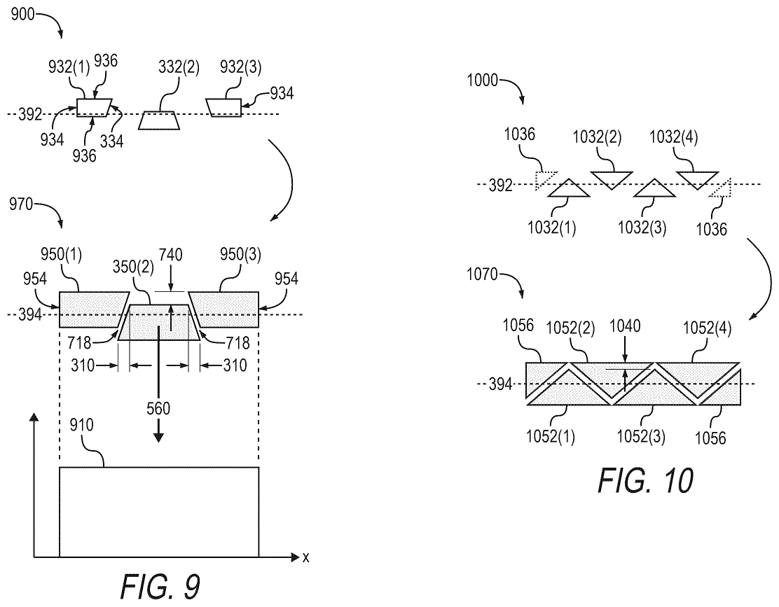

FIG. 9 illustrates another configuration 900 of trapezoidal light-pipe output ends in laser system 100, as well as a resulting line beam 970 in focal plane 198. Configuration 900 incorporates right-trapezoidal shapes to achieve a strict top-hat exposure profile. As compared to configuration 300 (FIG. 3), configuration 900 employs the alternating offsets orthogonal to array-axis 392 discussed above in reference to FIGS. 7A-C, but the outermost isosceles-trapezoidal output ends 332(1) and 332(3) are replaced by right-trapezoidal output ends 932(1) and 932(3). Although FIG. 9 only shows a single isosceles-trapezoidal output end 332(2) and associated isosceles-trapezoidal image 350(2), configuration 900 may include more than one isosceles-trapezoidal output end 332 between right-trapezoidal output ends 932 so as to generate line beam 970 with more than one isosceles-trapezoidal image 350 between right-trapezoidal images 950.

Right-trapezoidal output ends 932 are oriented such that (a) their bases 936 are parallel to array-axis 392, and (b) an outward-facing side 934, facing away from the remainder of the array of output ends, is orthogonal to array-axis 392. The resulting line beam 970 is similar to line beam 770 except that outermost isosceles-trapezoidal images 350(1) and 350(3) are replaced by right-trapezoidal images 950(1) and 950(3) having outward-facing sides 954 that are orthogonal to line-axis 394. In terms of image overlap, projection-overlap, and defocusing properties, line beam 970 is similar to line beam 770. However, by virtue of outward-facing sides 954 being orthogonal to line-axis 394, a workpiece traveling through line beam 970 along direction 560 orthogonal to line-axis 394 will experience an exposure profile 910 that is a strict top-hat. This characteristic of line beam 970 may render line beam 970 preferable over line beam 770 in some applications.

FIG. 10 illustrates one configuration 1000 of triangular light-pipe output ends in laser system 100, as well as a resulting line beam 1070 in focal plane 198. Configuration 1000 is similar to configuration 900 except for replacing trapezoidal shapes with corresponding triangular shapes (which may be considered equivalent to reducing one base-length to zero in each of the trapezoidal output ends of configuration 900). In configuration 1000, one or more isosceles-triangular output ends 1032 are bracketed by two right-triangular output ends 1036. The resulting line beam 1070 is thus composed of one or more isosceles-triangular images 1052 are bracketed by two right-triangular images 1056. The output ends of configuration 1000 are offset from array-axis 392 in alternating directions orthogonal thereto, whereby the resulting series of triangular images have corresponding alternating offsets with respect to line-axis 394, as indicated by offset 1040. These offsets produce gaps between the images constituting line beam 1070.

A workpiece traveling through line beam 1070 along a direction orthogonal to line-axis 394 will experience a strictly top-hat intensity profile similar to exposure profile 910 of FIG. 9. Line beam 1070 will have characteristics similar to those of line beam 970 in terms of image overlap, projection-overlap, exposure profiles, and defocusing properties except that corners of some of the triangular images may overlap in the presence of defocusing. For example, defocusing may cause a corner of isosceles-triangular image 1052(2) to overlap with a corner of isosceles-triangular image 1052(4).

While configuration 1000 produces a line beam 1070 that in many ways performs the same way as line beam 970, configuration 1000 may be modified to instead produce line beams that are still composed of triangular images but perform similarly to any one of line beams 370, 770, and 870, by eliminating offsets 1040, adding distance between the triangular images along line-axis 394, and/or omitting right-triangular output ends 1036. Additionally, the configurations and associated line beams discussed in reference to FIGS. 3 and 6-9 may be generalized to non-rectangular trapezoidal shapes, provided that adjacent sides of respective adjacent images of the line beam are parallel to each other. Similarly, configuration 1000 and line beam 1070 may be further generalized to other triangular shapes, wherein adjacent sides of respective adjacent triangular images of the line beam are parallel to each other. In even more general terms, output ends 132 of system 100 may be configured to produce line beam 170 as a series of polygon-shaped images distributed along the line-axis, wherein adjacent sides of respective adjacent polygon-shaped images are parallel. Furthermore, system 100 is not limited to polygon-shaped output ends and images. Although not necessarily advantageous for light-pipe manufacturing, output ends 132 and corresponding images 150 may take on shapes that are not polygons, provided that adjacent sides of respective adjacent images are complementary in shape. In the following, several more exemplary embodiments based on polygon-shapes are discussed.

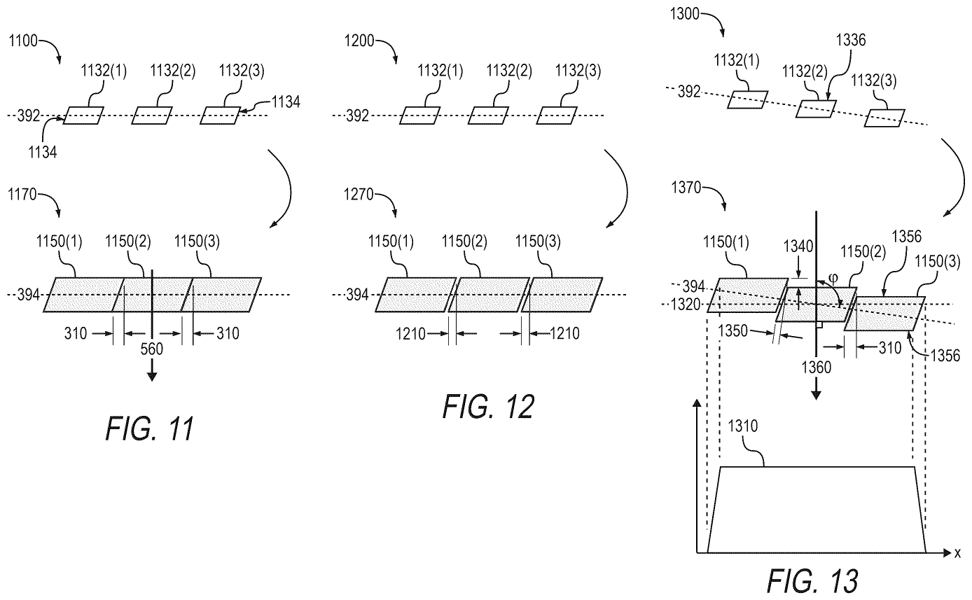

FIG. 11 illustrates one configuration 1100 of parallelogram-shaped light-pipe output ends 1132 in laser system 100, as well as a resulting seamless line beam in focal plane 198. In configuration 1100, output ends 1132 are shaped as non-rectangular parallelograms and arranged in a linear array along array-axis 392. Configuration 1100 generates a line beam 1170 that is composed of a linear array of non-rectangular-parallelogram-shaped images 1150. Images 1150 are centered on line-axis 394 with two sides of each image being parallel to line-axis 394. In this manner, images 1150 are stitched together seamlessly to form line beam 1170, in focal plane 198, with no gaps and no overlaps between adjacent images 1150. Yet, the projections of adjacent images 1150 onto line-axis 394 overlap in projection-overlap regions 310.

Despite being constructed from parallelogram-shaped images rather than trapezoidal images, line beam 1170 is similar to line beam 370 in terms of image-overlap, projection-overlap, exposure profiles, and defocusing properties. For example, a workpiece traveling through line beam 1170, in focal plane 198, in direction 560 orthogonal to line-axis 394 will experience an exposure distribution that is similar to exposure profile 610.

FIG. 12 illustrates another configuration 1200 of parallelogram-shaped light-pipe output ends 1132 in laser system 100, as well as a resulting line beam generated in focal plane 198, wherein the images contributing to the line beam are offset along the line-axis to produce gaps between adjacent images. Configuration 1200 is similar to configuration 1100 except that the distance between output ends 1132 is extended, such that adjacent images 1150 in the resulting line beam 1270 are separated from each other by gaps. These gaps are sufficiently small that the projections of adjacent images 1150 onto line-axis 394 overlap in projection-overlap regions 1210. Line beam 1270 is similar to line beam 870 in terms of image-overlap, projection-overlap, exposure profiles, and defocusing properties. For example, a workpiece traveling through line beam 1270, in focal plane 198, in direction 560 orthogonal to line-axis 394 will experience an exposure distribution that is similar to exposure profile 810.

Each of configurations 1100 and 1200 may be modified by replacing the outermost parallelogram-shaped output ends (output ends 1132(1) and 1132(3) in the depicted examples) by right trapezoids. Each of these right trapezoids are identical to the parallelogram except for the side facing away from the remainder of the output-end array being orthogonal to array-axis 392. With this modification, the resulting exposure profile, experienced by a workpiece traveling through line beam 1170 or 1270, will have abrupt edges instead of gradually tapering edges (e.g., tapering edges 602 in FIG. 6A).

FIG. 13 illustrates another configuration 1300 of parallelogram-shaped light-pipe output ends in laser system 100, as well as the images and resulting line beam created therefrom in focal plane 198, and a corresponding exposure profile. Configuration 1300 is based on parallelogram-shaped output ends 1132 and differs from configuration 1100 in that output ends 1132 are offset from each other in the dimension that is orthogonal to the sides 1336 of parallelogram-shaped output ends 1132. These offsets result in array-axis 392 being at an oblique angle to sides 1336, whereas array-axis 392 is parallel to sides 1336 in configuration 1100. Configuration 1300 produces a line beam 1370 composed of parallelogram-shaped images 1150 offset from each other in the direction orthogonal to sides 1356, as indicated by offset 1340. Sides 1356 of images 1150 correspond to sides 1336 of output ends 1132. This offset 1340 produce gaps between adjacent images 1150, thereby allowing for some amount of defocusing-induced enlargement of images 1150 without introducing actual image overlap.

Due to the parallelogram-shape of images 1150, offsets 1340 induce a tilt in line-axis 394, such that line-axis 394 is at an oblique angle to sides 1356. Depending on the size of offset 1340, adjacent images 1150 may still have overlapping projections onto line-axis 394, as shown in the depicted example characterized by projection-overlap regions 1350. However, a laser processing task performed by system 100 may benefit from more desirable properties of line beam 1370 when the workpiece travels through line beam 1370 along a direction 1360 that is orthogonal to an axis 1320 (parallel to sides 1356). Direction 1360 is at an oblique angle φ to line-axis 394. The projection-overlap of adjacent images 1150 onto axis 1320 is more extended than the projection-overlap of adjacent images 1150 onto line-axis 394. As a result, in the exposure profile experienced by a workpiece traveling through line beam 1370 along direction 1360, any defocusing-induced seam-effects are spread over larger sections of line-axis 394. These seam-effects are therefore less severe.

The projection-overlap of adjacent images 1150 onto axis 1320 is characterized by the same projection-overlap regions 310 as the projection-overlap in line beam 1170 with respect to line-axis 394. In other words, if offset 1340 was eliminated in line beam 1370, line beam 1370 would be identical to line beam 1170. As a result, a workpiece traveling through line beam 1370, in focal plane 198, along direction 1360 will experience an exposure profile 1310 that is a top-hat with tapered edges. In this scenario, line beam 1370 is similar to line beam 770 in terms of image-overlap, projection-overlap, exposure profiles, and defocusing properties.

Referring again to FIGS. 11 and 12, each of configurations 1100 and 1200 may be modified by replacing the outermost parallelogram-shaped output ends (output ends 1132(1) and 1132(3) in the depicted examples) by right trapezoids. Each of these right trapezoids are identical to the parallelogram except for modifying side 1134 (indicated in FIG. 11) facing away from the remainder of the output-end array to be orthogonal to array-axis 392. With this modification, the resulting exposure profile, experienced by a workpiece traveling through line beam 1170 or 1270, will have abrupt edges instead of gradually tapering edges (e.g., gradually tapering edges 602 in FIG. 6A). A similar modification may be made to configuration 1300, although here it may be most advantageous that the outermost parallelogram-shaped output ends are replaced by trapezoidal output ends with outward-facing sides that are orthogonal to an axis that is imaged onto axis 1320.

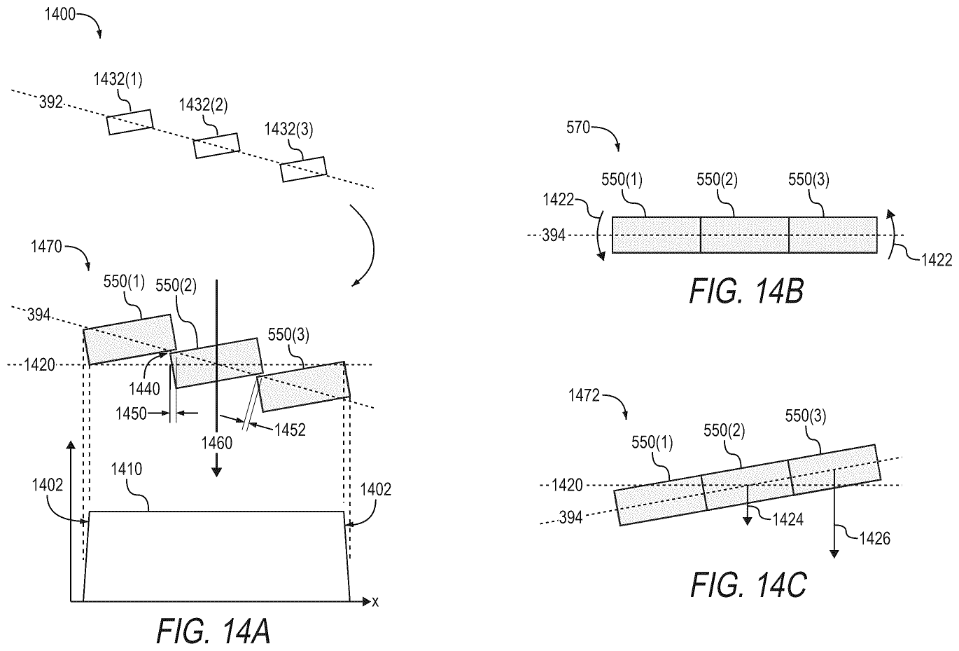

FIGS. 14A-C illustrate one configuration 1400 of rectangular light-pipe output ends, in laser system 100, generating a line beam composed of rectangular images that advantageously are separated by gaps while having projection-overlaps. FIG. 14A shows configuration 1400 together with a resulting line beam 1470 in focal plane 198 and one associated exposure profile.

Configuration 1400 includes a linear array of two or more identical rectangular output ends 1432 (three are depicted). Each output end 1432 is centered on array-axis 392 and oriented at the same oblique angle thereto. The resulting line beam 1470 is composed of a linear array of rectangular images 550. Images 550 are centered on line-axis 394 and are identical in size and orientation. In focal plane 198, adjacent images 550 are separated by gaps 1440.

To better understand the arrangement of rectangular images 550 in line beam 1470, FIGS. 14B and 14C show how the geometrical construction of line beam 1470 can be derived from no-gap rectangular line beam 570 through two geometrical operations. Consider first no-gap rectangular line beam 570, depicted in FIG. 14B, and rotate line beam 570 in focal plane 198 as indicated by arrows 1422. This rotation produces a rotated line beam 1472, depicted in FIG. 14C, which is still a no-gap rectangular line beam. Line-axis 394 of rotated line beam 1472 is rotated with respect to the initial orientation of line-axis 394 in FIG. 14B. FIG. 14C indicates both line-axis 394 pertaining to rotated line beam 1472 and an axis 1420. Axis 1420 is identical to line-axis 394 as it was initially oriented in FIG. 14B prior to rotation. Next, translate images 550 orthogonally to axis 1420, as indicated by arrows 1424 and 1426 in FIG. 14C, until arriving at the geometrical construction of line beam 1470 with adjacent images 550 being separated from each other by gaps 1440.

An advantageous projection-overlap exists with respect to axis 1420, onto which the projections of adjacent images 550 overlap in projection-overlap regions 1450. Since the translations imparted in FIG. 14C are orthogonal to axis 1420, the projection of line beam 1470 onto axis 1420 is indistinguishable from that of rotated no-gap rectangular line beam 1472. It follows that a workpiece traveling through line beam 1470, in focal plane 198, along a direction 1460 orthogonal to axis 1420, will experience an exposure profile 1410 that is a top-hat apart from tapering edges 1402.

In contrast to rotated no-gap rectangular line beam 1472, gaps 1440 between images 550 of line beam 1470, in focal plane 198, allow for some amount of defocusing-induced enlargement of images 550 without introducing actual image-overlap, similarly to line beam 770 composed of trapezoidal images. Additionally, when viewed in relation to axis 1420, line beam 1470 is similar to line beam 770 in terms of projection-overlap, exposure profiles, and defocusing properties. However, line beam 1470 may be generated using rectangular light pipes that may be simpler to manufacture than trapezoidal light pipes.

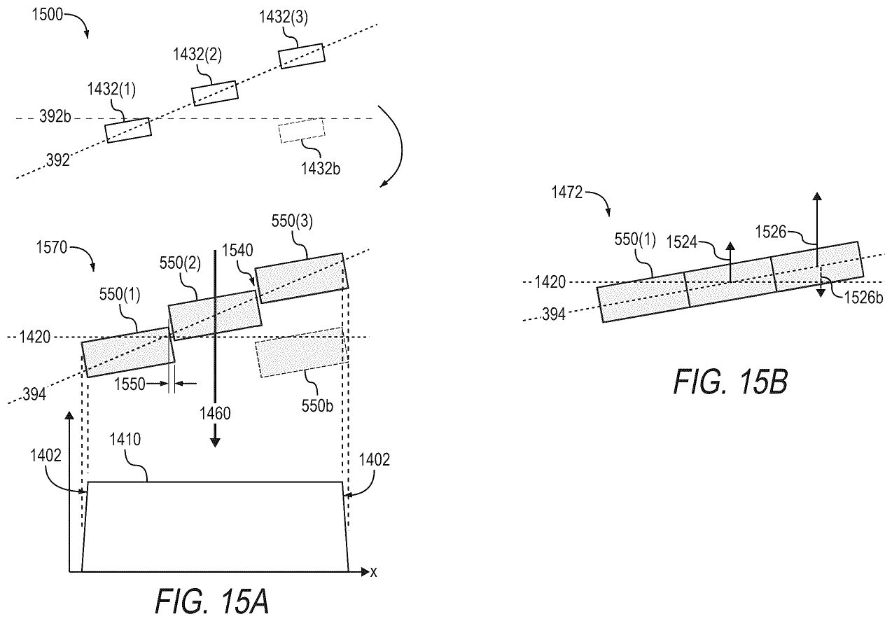

FIGS. 15A and 15B illustrate another configuration 1500 of rectangular light-pipe output ends, in laser system 100, generating a line beam composed of rectangular images that advantageously are separated by gaps while having projection-overlaps. FIG. 15A shows configuration 1500 together with a resulting line beam 1570 in focal plane 198 and one associated exposure profile. FIG. 15B shows that the geometrical construction of line beam 1570 may be derived from rotated no-gap rectangular line beam 1472 by translating images 550 orthogonally to axis 1420 as indicated by arrows 1524 and 1526. This translation direction is opposite that applied in FIG. 14C to produce the geometrical construction of line beam 1470. Yet, line beam 1570 is characterized by the same exposure profile 1410 as line beam 1470.

Configuration 1500 includes a linear array of two or more identical rectangular output ends 1432 (three are depicted). Each output end 1432 is centered on array-axis 392 and oriented at the same oblique angle thereto. Line beam 1570 is thus composed of a linear array of rectangular images 550. Images 550 are centered on line-axis 394 and are identical in size and orientation. In focal plane 198, adjacent images 550 are separated by gaps 1540.

As is the case for line beam 1470, advantageous projection-overlap exists with respect to axis 1420, onto which the projections of adjacent images 550 overlap in projection-overlap regions 1550. Line beam 1570 is similar to line beam 1470 in terms of defocusing properties and, in particular, in terms of projection-overlap, exposure profiles, and defocusing properties as they relate to axis 1420. As is the case for line beam 1470, it may be advantageous for a workpiece to travel through line beam 1570 along direction 1460.

Referring to FIGS. 14A-15B in combination, the geometrical constructions of line beams 1470 and 1570 may be generalized to other orthogonal translations of images 550 with respect to axis 1420, while still producing exposure profile 1410. The configuration of output ends 1432 is generalized accordingly. Generally, as long as the orthogonal translations are sufficient to produce gaps between adjacent images 550, the resulting line beam will be characterized by exposure profile 1410. One alternative example is indicated in FIGS. 15A and 15B. In this alternative example, image 550(3) is translated downwards as indicated by arrow 1526b in FIG. 15B and image 550b in FIG. 15A, such that images 550 have alternating orthogonal offsets from axis 1420. Axis 1420 than coincides with the line-axis of the line beam. In the corresponding output-end configuration, output end 1432(3) is at the location labeled 1432b, and output ends 1432 have alternating offsets with respect to an array axis 392b. This configuration may be beneficial in implementations where spatial constraints are incompatible with a significant oblique tilt of the output-end array axis and line-beam axis with respect to the travel direction of a workpiece.

Referring now to FIGS. 13-15B, each of the light-pipe output-end configurations producing line beams 1370, 1470, and 1570 may be configured such that adjacent images of the line beam have overlapping projections onto line-axis 394. For example, the depicted examples of line beams 1370 and 1470 have respective projection-overlap regions 1350 and 1452 with respect to line-axis 394 (as indicated in FIGS. 13 and 14A). Thus, each of line beams 1370, 1470, and 1570 provides some advantage in irradiation of a workpiece traveling through the line beam orthogonally to line-axis 394, as compared to the no-gap rectangular line-beam 570. However, greater advantages are achieved when the workpiece travels through the line beam along direction 1360 in the case of line beam 1370 and along direction 1460 in the cases of line beams 1470 and 1570.

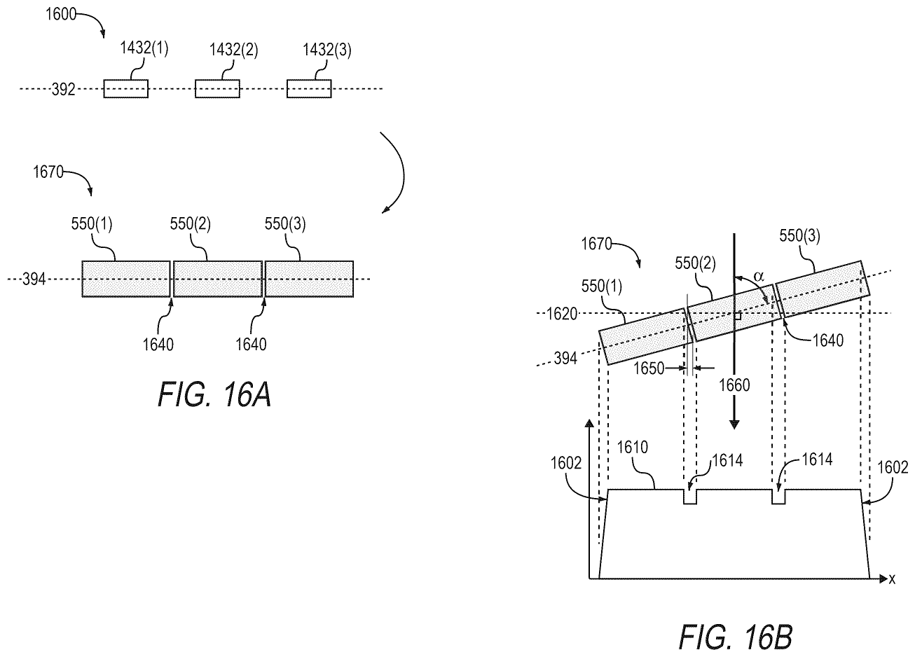

FIGS. 16A and 16B illustrate one configuration 1600 of parallel rectangular light-pipe output ends, in laser system 100, generating a rectangular line beam composed of rectangular images that are separated by gaps while having projection-overlaps with respect to an axis that is at an oblique angle to the line-axis. As shown in FIG. 16A, configuration 1600 includes a linear array of rectangular output ends 1432 arranged to be parallel to each other and each centered on array-axis 392. When implementing configuration 1600, system 100 generates line beam 1670 composed of a linear array of parallel rectangular images 550 each centered on line-axis 394. The distance between output ends 1432 is such that adjacent images 550, in focal plane 198, are separated by gaps 1640. Gaps 1640 allow for defocusing-induced enlargement of images 550 without introducing actual image-overlap.

FIG. 16B shows such an oblique orientation of line beam 1670 and a corresponding exposure profile. Consider a workpiece traveling through line beam 1670 along a direction 1660 that is at an oblique angle α with respect to line-axis 394 but orthogonal to an axis 1620. With suitable choices of the size of gap 1640 and oblique angle α, the projections of adjacent images 550 onto axis 1620 will overlap in projection-overlap regions 1650. Therefore, this workpiece will experience an exposure profile 1610 that is a top-hat except for dips 1614, in the regions of gaps 1640, and tapered edges 1602. Dips 1614 may be shallow. The performance of line beam 1670, when used in this manner, is similar to that of line beam 870 (composed of trapezoidal images) in terms of image-overlap, projection-overlap, exposure profiles, and defocusing properties.

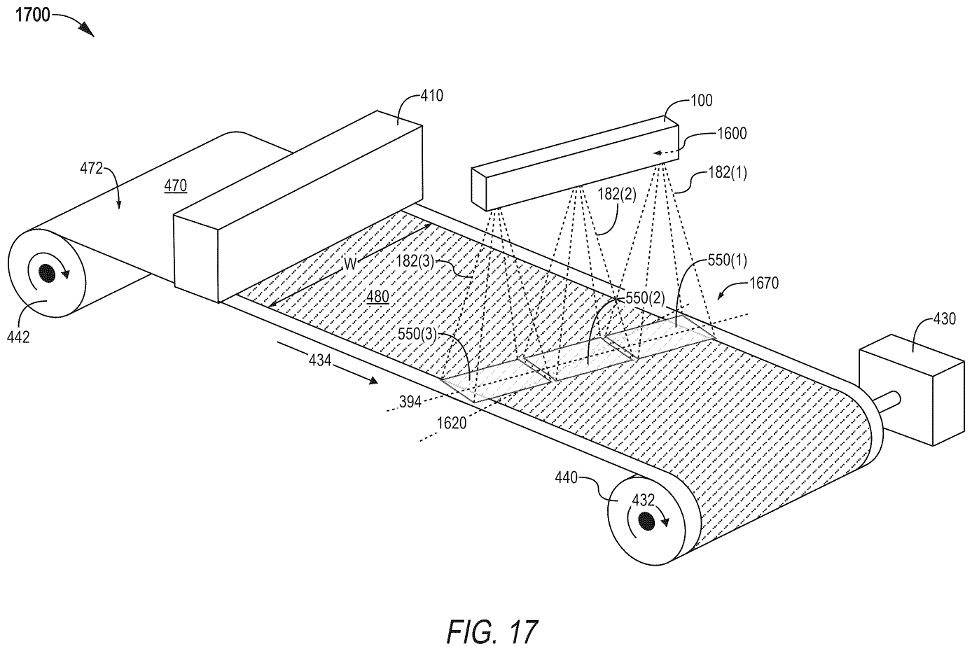

FIG. 17 illustrates one coating apparatus 1700 that utilizes laser system 100 to laser dry a coating lane 480 on a metal foil 470, wherein system 100 implements rectangular light pipe output ends according to configuration 1600 and oriented such that line beam 1670 is at an oblique angle to the travel direction of metal foil 470. Coating apparatus 1700 is similar to coating apparatus 400 except for this oblique relationship. Apparatus 1700 arranges system 100 such that travel direction 434 is at an oblique angle to line-axis 394 and orthogonal to axis 1620. The irradiation of coating lane 480 therefore benefits from the properties of line beam 1670 discussed above in reference to FIG. 16B.

Instead of implementing configuration 1600 in system 100, apparatus 1700 may utilize any one of configurations 1300, 1400, and 1500 with travel direction 434 being orthogonal to the corresponding ones of axes 1320 and 1420. Furthermore, in a manner similar to the use of such embodiments and oblique arrangements of system 100 to laser dry coating lane 480 in apparatus 1700, these embodiments and oblique arrangements of system 100 may be used to laser dry or otherwise laser-process other types of workpieces, for example ink printed onto a substrate.

In scenarios where a modest amount of actual image-overlap is acceptable, no-gap rectangular line beam 570 may suffice, provided that the workpiece travels through line beam 570 along a direction that is at an oblique angle to line-axis 394. A corresponding embodiment of system 100 implements rectangular output ends with distances therebetween set to produce no-gap rectangular line beam 570. This embodiment of system 100 may then be used in a manner that arranges line-axis 394 at an oblique angle to the travel direction of a to-be-processed workpiece. For example, this embodiment of system 100 may be implemented in the oblique relationship with travel direction 434 depicted in FIG. 16.

The present invention is described above in terms of a preferred embodiment and other embodiments. The invention is not limited, however, to the embodiments described and depicted herein. Rather, the invention is limited only by the claims appended hereto.

What is claimed is:

1. A laser system for generating a line beam, comprising:
a plurality of laser sources to generate a respective plurality of laser beams;
a plurality of light pipes arranged to transmit and homogenize the plurality of laser beams, respectively, so as to transform the plurality of laser beams into a respective plurality of homogenized laser beams; and
relay optics arranged to direct and image the homogenized laser beams from respective output ends of the light pipes onto a common focal plane, whereby the homogenized laser beams form a line beam that, in the common focal plane, includes respective images of the output ends of the light pipes stitched together along a line-axis of the line beam, wherein each mutually-adjacent pair of the images in the common focal plane are non-overlapping while having overlapping projections onto the line-axis.

2. The laser system of claim 1, wherein each mutually-adjacent pair of the images are separated from each other by a respective gap in the common focal plane.

3. The laser system of claim 1, wherein each of the homogenized laser beams emerges from the output end of the corresponding light pipe with a uniform intensity distribution, whereby each of the images in the common focal plane has a top-hat intensity distribution in the common focal plane, an outline of the top-hat intensity distribution having the same shape as the output end of the corresponding light pipe.

4. The laser system of claim 1, wherein the output ends of the light pipes and the corresponding images are shaped as polygons, and each mutually-adjacent pair of the images have respective mutually-adjacent sides that are (a) parallel to each other and (b) oriented at an oblique angle to the line-axis.

5. The laser system of claim 4, wherein:
the output ends are non-rectangular-trapezoidal, whereby the images are shaped as non-rectangular trapezoids; and
the images are oriented such that bases of the non-rectangular trapezoids are parallel to the line-axis.

6. The laser system of claim 5, wherein:
the non-rectangular trapezoids have alternating offsets in a first dimension orthogonal to the line-axis such that the non-rectangular trapezoids are separated from each other by gaps in the common focal plane; and
elimination of the offsets in the first dimension would eliminate the gaps between the non-rectangular trapezoids without introducing an overlap therebetween.

7. The laser system of claim 4, wherein the output ends are shaped as non-rectangular parallelograms, and each of the images are centered on the line-axis with a gap between each mutually-adjacent pair of the images in the common focal plane.

8. The laser system of claim 4, wherein the output ends are shaped as triangles, and the images are oriented such that each of the triangles as imaged has a side parallel to the line-axis.

9. The laser system of claim 4, wherein the output ends are shaped as rectangles, and the images are oriented such that sides of each of the rectangle, as imaged, are at oblique angles to the line-axis.

10. The laser system of claim 1, wherein each of the light pipes has the same transverse cross section from an input end thereof to the output end.

11. The laser system of claim 1, wherein the laser sources are arranged in a linear array, the laser beams have mutually-parallel propagation directions, the light pipes are arranged in a linear array, the homogenized laser beams have mutually-parallel propagation directions, and the relay optics image the homogenized laser beams from the output ends of the light pipes onto the common focal plane with identical magnification imposed on each of the homogenized laser beams.

12. The laser system of claim 11, wherein the output ends of the light pipes are shaped as polygons, and each mutually-adjacent pair of the output ends have respective mutually-adjacent sides that are (a) parallel to each other and (b) at an oblique angle to an array-axis spanned by the output ends of the linear array of light pipes.

13. The laser system of claim 12, wherein the output ends of the light pipes are identical in shape and size but oriented such that each mutually-adjacent pair of the output ends have mutually-opposite orientations with respect to an array-axis of the linear array of the light pipes.

14. The laser system of claim 13, wherein the shape is a non-rectangular trapezoid or a triangle.

15. The laser system of claim 12, wherein the output ends of the light pipes are identical in shape, size, and orientation.

16. The laser system of claim 15, wherein each of the output ends is shaped as a non-rectangular parallelogram.

17. The laser system of claim 15, wherein each of the output ends is shaped as a rectangle and oriented such that sides of the rectangle are at oblique angles to the array-axis.

18. A battery-electrode coating apparatus, comprising:
a transport system to drive a metal foil along a lengthwise dimension thereof;
a coating applicator disposed above the metal foil to form one or more coating lanes on the metal foil when the transport system drives the metal foil beneath the coating applicator; and
the laser system of claim 1 disposed after the coating applicator to dry the one or more coating lanes with the line beam as the transport system drives the metal foil through the line beam.

19. A laser apparatus for processing a workpiece, comprising:
a laser system including:
a plurality of laser sources to generate a respective plurality of laser beams;
a plurality of light pipes arranged to transmit and homogenize the plurality of laser beams, respectively, so as to transform the plurality of laser beams into a respective plurality of homogenized laser beams, and
relay optics arranged to direct and image the homogenized laser beams from respective output ends of the light pipes onto a common focal plane, whereby the homogenized laser beams form a line beam that, in the common focal plane, includes respective images of the output ends of the light pipes arranged along a line-axis of the line beam; and
a transport system to drive the workpiece through the line beam along a transport direction that is parallel to the common focal plane and at an oblique angle to the line-axis;
wherein, in the common focal plane, each mutually-adjacent pair of the images are non-overlapping while having overlapping projections onto a first axis that is orthogonal to the transport direction and contained in the common focal plane.

20. The laser apparatus of claim 19, wherein each mutually-adjacent pair of the images are separated from each other by a respective gap in the common focal plane.

21. The laser apparatus of claim 19, wherein each of the output ends is rectangular in shape, whereby the images are shaped as respective rectangles, each of the rectangles being (a) identical in size and orientation and (b) centered on the line-axis with a gap between each mutually-adjacent pair of the images in the common focal plane.

22. The laser apparatus of claim 21, wherein each of the rectangles is parallel to the line-axis.

23. The laser apparatus of claim 21, wherein each of the rectangles is at an oblique angle to the line-axis.

24. The laser apparatus of claim 21, wherein the output ends are identical in size.

25. The laser apparatus of claim 19, wherein each of the output ends and each of the images is shaped as a parallelogram, each of the images being (a) identical in size and orientation and (b) centered on the line-axis with a gap between each mutually-adjacent pair of the images in the common focal plane.

26. The laser apparatus of claim 25, wherein:
for each of the images, two sides of the corresponding parallelogram are parallel to the first axis;
in the common focal plane, the images are offset from each other orthogonally to the first axis; and
elimination of said offset orthogonally to the first axis would eliminate the gap between the images of each mutually-adjacent pair without introducing an overlap therebetween.

27. The laser apparatus of claim 19, wherein each of the light pipes has the same transverse cross section from an input end thereof to the output end.

28. The laser apparatus of claim 19, wherein the laser sources are arranged in a linear array, the laser beams have mutually-parallel propagation directions, the light pipes are arranged in a linear array, the homogenized laser beams have mutually-parallel propagation directions, and the relay optics image the homogenized laser beams from the output ends of the light pipes onto the common focal plane with the same magnification imposed on each of the homogenized laser beams.
